(19) United States
(12) Patent Application Publication
(10) Pub. No.: US 2013/0117793 A1
(43) Pub. Date: May 9, 2013

(54) REAL-TIME TRANSLATION SYSTEM FOR DIGITAL TELEVISIONS AND METHOD THEREOF

(71) Applicants: Ping-Che YANG, Kaohsiung City (TW); Liang-Pu CHEN, New Taipei City (TW); Tsun KU, Taipei City (TW); Wen-Tai HSIEH, Taipei City (TW)

(72) Inventors: Ping-Che YANG, Kaohsiung City (TW); Liang-Pu CHEN, New Taipei City (TW); Tsun KU, Taipei City (TW); Wen-Tai HSIEH, Taipei City (TW)

(21) Appl. No.: 13/493,877

(22) Filed: Jun. 11, 2012

(30) Foreign Application Priority Data
Nov. 9, 2011 (TW) 100140864

(51) Int. Cl. G06F 17/28; H04N 21/643

(52) U.S. Cl. 725/110; 725/109

(57) ABSTRACT

A real-time translation system for digital televisions and method thereof. It includes a real-time translation server, an operating unit, and a digital television apparatus including a digital signal receiver, a display device, an Internet-enabled device, an operation signal receiving module, and a processor. The processor is connected to the digital signal receiver, the display device, the Internet-enabled device, and the operation signal receiving module. The processor is used for transferring an original digital text signal to the real-time translation server through the communication network for translation when the operation signal receiving module receives a translation operation signal from the operating unit, receiving a translated digital text signal corresponding to the original digital text signal and returned by the real-time translation server, replacing the original digital text signal with the translated digital text signal, and displaying the translated digital text signal and the digital television signal on the display device.

### CROSS-REFERENCE TO RELATED APPLICATION

This application claims the benefit of Taiwan Patent Application No. 100140864, filed on Nov. 9, 2011, which is hereby incorporated by reference for all purposes as if fully set forth herein.

### BACKGROUND OF THE INVENTION

1. Field of Invention

The present invention relates to a real-time translation system for digital televisions and method thereof, and more particularly to a real-time translation system for digital televisions and method for translating a digital television content in real-time and method thereof.

2. Related Art

Nowadays, a real-time translation service is not provided for most of real-time messages of a digital television platform operator, and a real-time translation service is also not provided for real-time messages (for example, a news ticker, a social network service, or any digital signal including a real-time text content) in an Internet-enabled set-top box (STB) box of an digital television platform operator.

In addition, when a user watches a television program played in a non-native language, the user relies on subtitles of the television program to understand the context of the program. Sometimes, the subtitle is not clearly displayed. Although the television program can be played in a digital manner, when the subtitle is stored in an image format, display quality of the subtitle may be still unqualified due to many reasons.

For example, if a data size of a text for storing the subtitles in an image format is excessively small, the display quality of the subtitle is decreased. In another example, if the resolution of the subtitle stored in an image format does not match the display resolution of the television program, the final display quality of the subtitle is unacceptable. If a video display system for displaying the television program includes a television receiver and a display device, for example, a projector, a plasma display panel (PDP), or a liquid crystal display (LCD) panel, the resolution of the television receiver may not match the resolution of the display device, resulting in high distortion of the display subtitle.

As stated above, as long as the subtitle is stored in the image format, whether subtitle data of the subtitle is transferred separately form the television program or not, the display quality of the subtitle cannot be ensured. Furthermore, when the subtitle is a image which is a part of each of a plurality of images of the television program, the displayed subtitle becomes worse, resulting in undesirable watch experience of the user.

In the prior art, no real-time translation function is provided for digital signals including a subtitle signal. It is not real real-time translation for following example. An image and a sound are controlled to be delayed for waiting the translation is completed, and then the translated subtitle is combined with the delayed image and sound for being presented to the user. Alternatively, a real-time translation mechanism cannot be achieved by an Internet-disabled STB with the existing product. It can be achieved by an extremely specification machine with high cost.

### SUMMARY OF THE INVENTION

The present invention provides a real-time translation system for digital televisions and method thereof, for transferring a real-time translation content in a digital signal to a real-time translation server for translation, so that a played content and a translated text can be played synchronously.

The present invention provides a real-time translation system for digital televisions. The system comprises a real-time translation server, an operating unit, and a digital television apparatus, where the operating unit is used for outputting a translation operation signal. The digital television apparatus comprises a digital signal receiver, a display device, an Internet-enabled device, an operation signal receiving module, and a processor. The digital signal receiver is used for receiving a digital television signal and an original digital text signal. The display device is used for displaying the digital television signal and the original digital text signal. The Internet-enabled device is connected to the real-time translation server through a communication network. The operation signal receiving module is used for receiving the translation operation signal. The processor is connected to the digital signal receiver, the display device, the Internet-enabled device, and the operation signal receiving module, and is used for transferring the original digital text signal to the real-time translation server through the communication network for translation when the operation signal receiving module receives the translation operation signal, receiving a translated digital text signal corresponding to the original digital text signal and returned by the real-time translation server, replacing the original digital text signal with the translated digital text signal, and displaying the translated digital text signal and the digital television signal on the display device.

In an embodiment of the present invention, the operating unit is a multifunctional remote controller, comprising a translation operation button.

In an embodiment of the present invention, the real-time translation server further comprises a text comparison module and a translation database.

In an embodiment of the present invention, the digital signal receiver, the Internet-enabled device, the operation signal receiving module, and the processor are disposed on a digital set-top box (STB). The display device is a television, and the television is connected to the processor of the digital STB.

In an embodiment of the present invention, the digital television apparatus is an Internet-enabled digital television (DTV).

In an embodiment of the present invention, the processor is further connected to a digital television server through the communication network to receive the digital television signal and the original digital text signal.

In an embodiment of the present invention, the digital signal receiver is sued for receiving digital television signals and original digital text signals provided by a plurality of broadcasting stations through a wired or wireless network.

In an embodiment of the present invention, the original digital text signal is a first language subtitle, and the translated digital text signal is a second language subtitle.

In an embodiment of the present invention, after receiving the original digital text signal with a predetermined encoding length, the processor transfers the original digital text signal to the real-time translation server for translation.

In an embodiment of the present invention, the processor further comprises a preloading procedure, for preloading the digital television video signals and the original digital text signals that are not played, and synchronously playing the digital television video signals and the translated digital text signals after receiving the translated digital text signals.

The present invention provides a real-time translation method for digital televisions. The method comprises: first, an operating unit outputting a translation operation signal; a digital signal receiver of a digital television apparatus receiving a digital television signal and an original digital text signal; an operation signal receiving module receiving the translation operation signal; an Internet-enabled device being connected to a real-time translation server through a communication network; according to the translation operation signal, a processor transferring the original digital text signal to the real-time translation server through the communication network for translation; receiving a translated digital text signal corresponding to the original digital text signal and returned by the real-time translation server; and replacing the original digital text signal with the translated digital text signal, and displaying the translated digital text signal and the digital television signal on a display device.

In an embodiment of the present invention, the method further comprises: the operating unit outputting a channel selection operation signal; according to the channel selection operation signal, the digital television apparatus playing a digital television signal of a selected channel; and when the operating unit outputs the translation operation signal, performing the preloading procedure corresponding to the selected channel to preload the digital television video signals and the original digital text signals that are not played, and synchronously play the digital television video signals and the translated digital text signals after receiving the translated digital text signals.

In an embodiment of the present invention, the step of the real-time translation server performing translation further comprises: obtaining an original digital text signal; a text comparison module determining whether a part of the original digital character text signal or the whole original digital text signal exists in a translation database; and if yes, translating the original digital character signal according to data in the translation database, and listing corresponding translated unknown terms, if no, reserving the original digital text signal for translation; analyzing the unknown terms to be translated, and listing several relevant candidate translated unknown terms; listing single word hierarchy translations of the unknown terms to be translated, for example, performing translation in combination according to the relevant candidate translated unknown terms; and calculating the number of occurrences of each translation combination, so as to determine translation results of the unknown terms to be translated.

In an embodiment of the present invention, the step of the real-time translation server performing translation further comprises the following steps for translating a polysemant: determining that a polysemant is comprised in a translation of the original digital text signal, and listing a polysemant candidate list; selecting an appropriate combination of the unknown terms and the candidate list to generate a translation corpus and a translation result of the translation corpus; and comparing word meanings, and selecting a translation result of the most associated translation corpus, so as to determine a translation result of the polysemant.

### BRIEF DESCRIPTION OF THE DRAWINGS

The present invention will become more fully understood from the detailed description given herein below for illustration only, and thus are not limitative of the present invention, and wherein:

FIG. 1 is a perspective block diagram of components of a system according to a first embodiment of the present invention;

FIG. 2 is a perspective block diagram of components of a system according to a second embodiment of the present invention;

FIG. 3 is a flow chart of the first embodiment of the present invention; and

FIG. 4 is a flow chart of a real-time translation server translating an unknown text and a polysemant according to the present invention.

### DETAILED DESCRIPTION OF THE INVENTION

In order to make the features and advantages of the present invention clearer and more comprehensible, the present invention is described in detail below with reference to embodiments and the accompanying drawings.

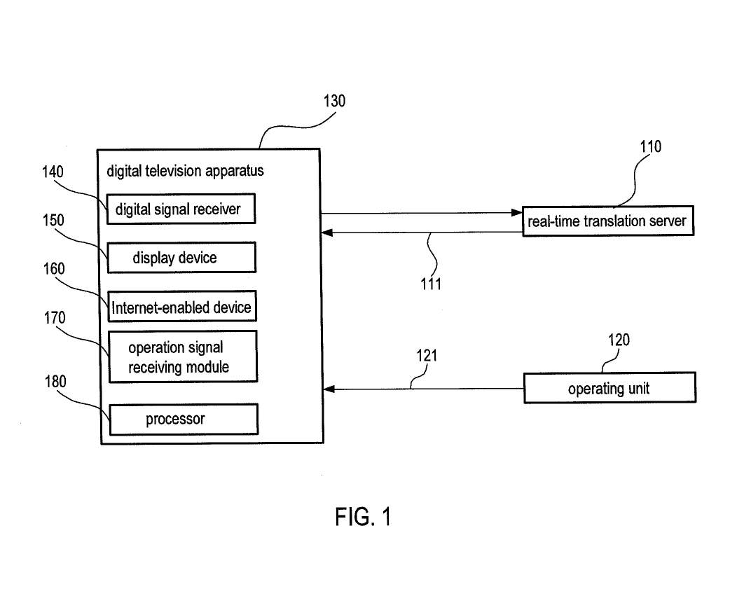

FIG. 1 is a schematic block diagram of components of a system according to the present invention. In FIG. 1, a real-time translation system for digital televisions is shown.

The system includes a real-time translation server 110, an operating unit 120, and a digital television apparatus 130, where the operating unit 120 is used for outputting a translation operation signal 121. The digital television apparatus 130 includes a digital signal receiver 140, a display device 150, an Internet-enabled device 160, an operation signal receiving module 170, and a processor 180. The digital signal receiver 140 is used for receiving a digital television signal and an original digital text signal. The display device 150 is used for displaying the digital television signal and the original digital text signal. The Internet-enabled device 160 is connected to the real-time translation server 110 through a communication network. The operation signal receiving module 170 is used for receiving the translation operation signal 121. The processor 180 is connected to the digital signal receiver 140, the display device 150, the Internet-enabled device 160, and the operation signal receiving module 170. The processor 180 transfers the original digital text signal to the real-time translation server 110 through the communication network for translation when the operation signal receiving module 170 receives the translation operation signal 121. And then, the processor 180 receives a translated digital text signal 111 corresponding to the original digital text signal, wherein the translated digital text signal 111 is returned by the real-time translation server 110. Lastly, the processor 180 replaces the original digital text signal with the translated digital text signal 111, and the translated digital text signal 111 and the digital television signal are displayed on the display device 150. The original digital text signal may be a first language subtitle, for example, a Chinese subtitle, and the translated digital text signal may be a second language subtitle, for example, an English subtitle or a Japanese subtitle.

The digital television apparatus may be a DTV with an Internet-enabled device or a combination of an Internet-enabled digital television STB and a television. The DTV denotes a television capable of directly receiving and processing an external digital television signal or a television having a built-in digital television decoder. In the combination of the digital television STB and the television, the digital television STB converts a digital television signal into an analog television signal for displaying on the analog television.

In this embodiment, the operating unit 120 is preferably a multifunctional remote controller, including a translation operation button for outputting a translation operation signal 121. The multifunctional remote controller may be further used for transferring a channel selection signal to the digital television apparatus 130, so as to enable the digital television apparatus 130 to play a digital television signal of a selected channel.

In this embodiment, the real-time translation server 110 further includes a text comparison module and a translation database. The translation database stores a corresponding relation between more than two languages for translation. It can be, for example, one of various commercially available translation dictionaries, translation unknown terms libraries, and on-line translation databases. The text comparison module can determine if a part of the original digital character text signal or the whole original digital text signal exists in the translation database. If yes, the a part of original digital text signal or the whole original digital text signal may be translated according to data in the translation database, and corresponding translated unknown terms are listed. If no, it is indicated that the original digital text signal is an unknown text, and the original digital text signal is reserved for translation. The unknown terms reserved for translation are analyzed. A part of the unknown term is compared with the data in the translation database, and several relevant candidate terms are listed. For example, the unknown text is divided into several words, and then the several relevant candidate translated terms are the terms that each is composed of at least one of the divided words and other words in the translation database (for example, any unknown terms including the at least one of the divided word and having less than four words). For example, if “ [symbol] (lei bao, it means base in Chinese for the term in the first language)” is an unknown text, “ [symbol] (lei bao)” is divided into two words “ [symbol] lei)” and “ [symbol] (bao)”. According to the divided word “ [symbol] (lei)”, the translation database is searched for relevant candidate translated terms such as “ [symbol] (lei qiu, it means softball in Chinese)”, “ [symbol] (lei shou. it means baseman in Chinese)”, “ [symbol] (yi lei, it means first base in Chinese)”. Then, a statistical analysis is performed on a plurality of translation results of each relevant candidate translated term. For the word “ [symbol] (lei)”, one of the candidate translated terms, for example “ [symbol] (yi lei)”, may have multiple translation results, such as “first”, “first base”, “1st”, “base”, and “bases” in English for the terms in the second language and another candidate translated term “ [symbol] (lei qiu)” may also have multiple translation results. Then, all of translation results containing “ [symbol] (lei)” and “ [symbol] (qiu)” are added up for a statistical evaluation, and the translation result with the highest number is chosen as a final translation result. For example, translation results of the relevant candidate translated terms of the divided word “ [symbol] (lei)” and the divided word “ [symbol] (bao)” are added up and the result are as follows. The number of times for “ [symbol] (yi lei)” being translated into “base” is 375, the number of times for “ [symbol] (lei qiu)” being translated into “softball” is 105, and the number of times for “ [symbol] (bao bao)” being translated into “bag” is 113. According to the translation result having the largest number of times, it can be determined that the most possible translation result for “ [symbol] (lei is “base”.

Furthermore, the text comparison module may perform translation for a polysemant, that is, some terms may correspond to multiple translation results, and a most appropriate translation result needs to be selected from the multiple translation results. First, a polysemant candidate list may be listed. For example, for a term “ [symbol] (ti qi, it means mention, when it comes to, lift, rise and so on in Chinese)” in a sentence for translating, a possible candidate list may include “mention”, “when it comes to”, “lift”, “rise”, and “bring”. Next, other appropriate words(or terms) and the words(or terms) in the candidate list are selected and combined to generate a plurality of translation corpora and corresponding translation results. For example, through bilingual parallel corpus (for example, Hong Kong News Parallel Corpus), a plurality of sentences and terms comprising “ [symbol] (ti qi)” are found. The plurality of translation corpora are found according to the plurality of sentences and terms, wherein each translation corpus is the highest frequency term get by a skipped bigram in each of the plurality of sentences and terms. For example, through the skipped bigram, the translation corpora comprise “ [symbol] (ti qi xing nang)”, [symbol] (ti qi wang shi)“, and “ [symbol] (ti qi an jian)”. The translation results corresponding to the above translation corpora are “Life up the package”, “Mention the past”, and “When it comes to the case”. Then, word meanings corresponding to the translation corpora in the first language are compared, and the translation result with the highest association for word meanings is selected as the final translation result for the polysemant. For example, through a synonym dictionary (for example, the Dictionary of Synonyms (Mei et. al. 1984)), the word meaning of a combination term of the polysemant “ [symbol] (ti qi an zi)” is compared with each word meaning of the multiple translation corpuses found above, wherein the combination term means a term combined with the polysemant and a text preceding or following the polysemant in the sentence for translating. If the translation corpus “ [symbol] (ti qi an jian)” has the same meaning as the polysemant combination [symbol] [symbol] (ti qi an zi)” in Chinese, it can be determined that the translation corpus [symbol] (ti qi an jian)” is the appropriate translation selection. In the translation result “When it comes to the case” of [symbol] (ti qi an jian)”, the corresponding part of the translation result corresponding to the polysemant is “When it comes to”, so it can be determined that “When it comes to” is the final translation result of the polysemant.

After translation of all unknown texts and polysemants in the original digital text signal, the text comparison module may combine the translation result obtained from the translation database and the translation results of the unknown texts and the polysemants, so as to generate the translated digital text signal corresponding to the original digital text signal.

In an embodiment of the present invention, the digital signal receiver 140, the Internet-enabled device 160, the operation signal receiving module 170, and the processor 180 are disposed on a digital STB. The display device 150 is a television, and the television is connected to the processor 180 of the digital STB. In another embodiment, the digital television apparatus is an Internet-enabled DTV, and includes all the components of the real-time translation system.

The processor 180 may be connected to a remote digital television server (for example, an Internet Protocol Television (IPTV) system, an Internet-enabled television, a Chunghwa Telecom's Multimedia-on-Demand (MOD)) through the communication network to receive the digital television signal and the original digital text signal. In this embodiment, the digital signal receiver 140 is used for receiving digital television signals and original digital text signals provided by digital television channels of a plurality of digital broadcasting stations. The digital broadcasting station is, for example, the Taiwan Television (TTV), the China Television (CTV), the Chinese Television System (CTS), the Formosa Television, and the Public Television Service (PTS) in Taiwan.

Furthermore, in order to speed up the translation process to immediately present the translation result, after receiving an original digital text signal with a predetermined encoding length (for example, 500 characters), the processor 180 may transfer the original digital text signal the real-time translation server 110 for translation.

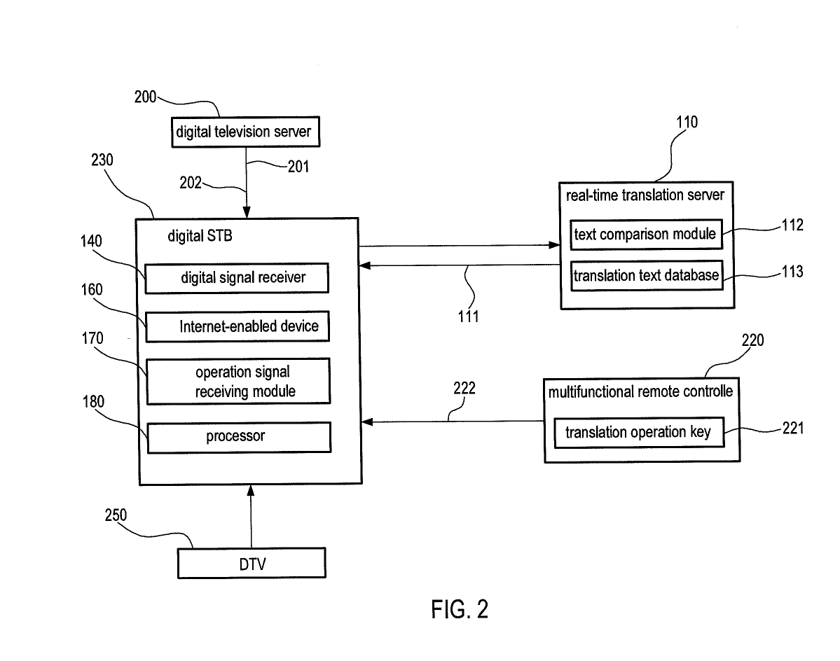

FIG. 2 is a schematic block diagram of components of a system according to a second embodiment of the present invention. In FIG. 2, a further practical application of the real-time translation system for digital televisions is shown. In this embodiment, the system includes a real-time translation server 110, a multifunctional remote controller 220, a digital television server 200, and a digital STB 230. The real-time translation server 110 includes a text comparison module 112 and a translation database 113. The multifunctional remote controller 220 may first output a channel selection signal for selecting a channel for watching. The multifunctional remote controller 220 outputs a translation operation signal 222 by using a translation operation button 221 disposed on the multifunctional remote controller 220, so as to perform a preloading procedure. Here, the multifunctional remote controller 220 may be a physical remote controller, a virtual remote controller, or an electronic device with remote control functions, such as mobile phones, touch devices. In addition, the button 221 may be a physical button, a virtual button on the virtual remote controller such as options, buttons or icons, or a touch button of an electronic device such as mobile phones, touch devices. The digital television server 200 transfers an original digital text signal 202 to the real-time translation server 110 for text comparison translation. Moreover, the digital television server 200 further transfers a digital television video signal 201 to the digital STB 230, so that a DTV 250 plays the digital television signal 201 and a translated digital text signal 111.

In this embodiment, the processor 180 further includes a preloading procedure, for preloading a digital television video signals and an original digital text signals that are not played, transferring the original digital text signal that is not played to the real-time translation server 110 for translation, and synchronously playing the digital television video signals and the translated digital text signals after receiving the translated digital text signal. That is to say, in the preloading procedure, when the television plays a digital content at one time point, a content which will be played at a next time point (after the one time point) is preloaded, and then, the original digital text signal (for example, a subtitle) is first transferred to the real-time translation server for translation, and the translated digital text signal is received. Thus, when the digital content to be played needs to be translated, the translated digital text signal 111 is immediately provided as a translated subtitle, so that the translated subtitle and the digital television video signal 201 to be played can be played synchronously. Therefore, as no time lapse between the audiovisual and subtitle, the problems of still picture frames or unsynchronized sound and image can be avoided.

The digital signal receiver 140, the Internet-enabled device 160, the operation signal receiving module 170, and the processor 180 are disposed on the digital STB 230. The DTV 250 is connected to the processor 180 of the digital STB 230.

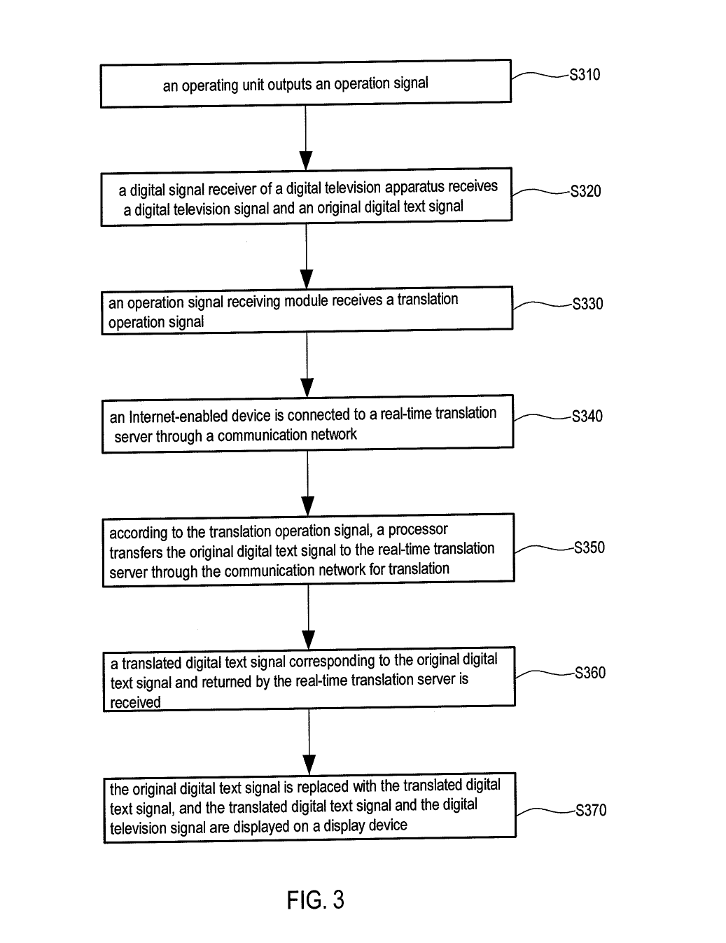

FIG. 3 is a flow chart of an embodiment of the present invention. In FIG. 3, the main steps are described as follows.

In Step S310, an operating unit outputs an operation signal.

In this embodiment, the operating unit is preferably a multifunctional remote controller. The multifunctional remote controller may output a channel selection operation signal through an output signal of the multifunctional remote controller, so that a digital multimedia play device plays a selected channel, and then, translation is performed for a played content. The multifunctional remote controller may further disposed with a translation operation button.

In Step S320, a digital signal receiver of a digital television apparatus receives a digital television signal and an original digital text signal.

In Step S330, an operation signal receiving module receives a translation operation signal.

In Step S340, an Internet-enabled device is connected to a real-time translation server through a communication network.

In Step S350, according to the translation operation signal, a processor transfers the original digital text signal to the real-time translation server through the communication network for translation.

In this embodiment, after receiving an original digital text signal with a predetermined encoding length, a digital television STB transfers the original digital text signal to the real-time translation server for translation.

In Step S360, a translated digital text signal corresponding to the original digital text signal and returned by the real-time translation server is received.

In Step S370, the original digital text signal is replaced with the translated digital text signal, and the translated digital text signal and the digital television signal are displayed on a display device.

Other detailed implementation of the steps of the method according to the present invention is as stated above, and details will not described here again.

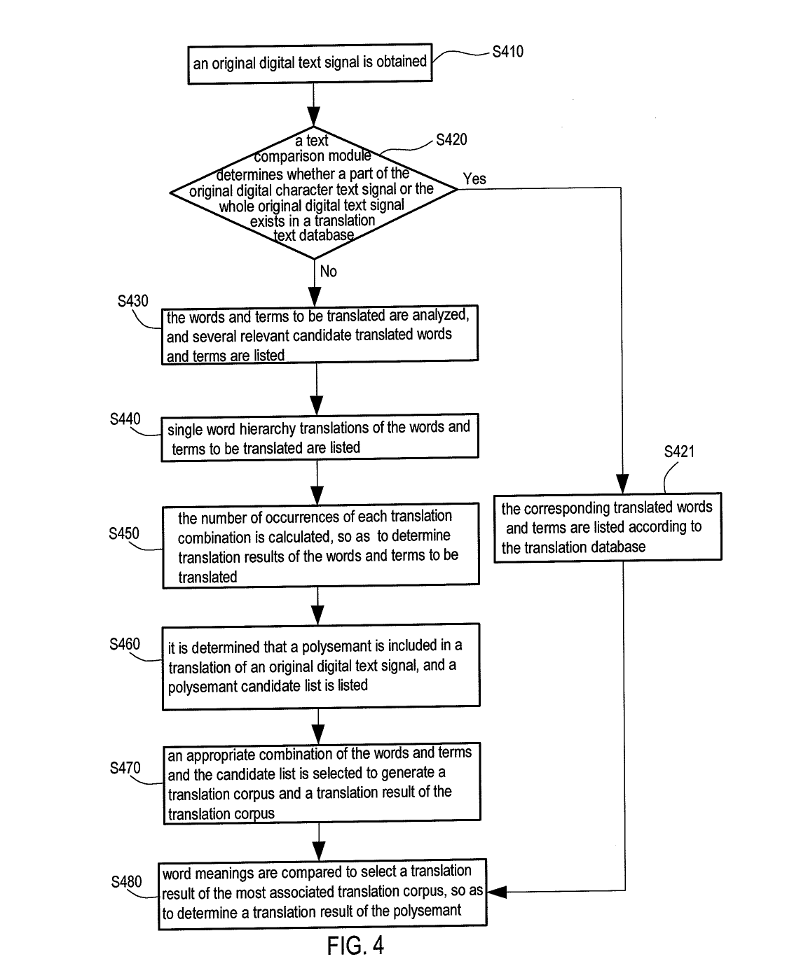

FIG. 4 is a flow chart of a real-time translation server translating an unknown text and a polysemant according to the present invention. The steps for translating the unknown text and the steps for translating the polysemant may be performed individually. The unknown text may be translated first and then the polysemant is translated, or the polysemant is translated first and then the unknown text is translated.

The steps for translating the unknown text are described as follows.

In S410, an original digital text signal is obtained.

In S420, a text comparison module determines whether a part of the original digital character text signal or the whole original digital text signal exists in a translation database, and if yes, the original digital text signal may be translated according to data in the translation database, and corresponding translated unknown terms are listed; if no, it is indicated that the original digital text signal is an unknown text, and the original digital text signal is reserved for translation.

In S421, the corresponding translated unknown terms are listed according to the translation database.

In S430, the unknown terms to be translated are analyzed, and several relevant candidate translated unknown terms are listed. For example, a part of the unknown terms to be translated is compared with the translation database, and the several relevant candidate translated unknown terms are listed.

In S440, single word hierarchy translations of the unknown terms to be translated are listed. For example, translation in combination is performed according to the relevant candidate translated unknown terms.

In S450, the number of occurrences of each translation combination is calculated, so as to determine translation results of the unknown terms to be translated.

The steps for translating the polysemant are described as follows.

In S460, it is determined that one of polysemant and phrases is included in a translation of an original digital text signal, and a candidate list for at least one of polysemant and phrases.

In S470, an appropriate combination of the unknown terms and the polysemant candidate list is selected to generate a translation corpus and a translation result of the translation corpus.

In S480, word meanings are compared to select a translation result of the most associated translation corpus, so as to determine a translation result of the polysemant.

Other detailed implementation for the real-time translation server translating the unknown text and the polysemant is as stated above, and details will not be described here again.

In view of the above, the advantage of the present invention is that, through an Internet-enabled mechanism, a real-time translation server translates a digital signal including a captured digital text massage received by the STB of the digital television apparatus in real time. Since a real-time message of the digital text signal on the STB is generally a short text message, through the system and method according to the present invention, the translation can be immediately completed, and the translation result can be returned to the digital television apparatus, so that the translation result and the digital television signal are played synchronously. Furthermore, through the translation mechanism provided by the present invention, unknown texts and polysemants that often occur in the real-time message translation can be preprocessed before translation, thereby achieving the effect of real-time translation.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A real-time translation system for digital televisions, comprising:
a real-time translation server;
an operating unit, for outputting a translation operation signal; and
a digital television apparatus, comprising:
a digital signal receiver, for receiving a digital television signal and an original digital text signal;
a display device, for displaying the digital television signal and the original digital text signal;
an Internet-enabled device, connected to a real-time translation server through a communication network;
an operation signal receiving module, for receiving the translation operation signal; and
a processor, connected to the digital signal receiver, the display device, the Internet-enabled device, and the operation signal receiving module, for transferring the original digital text signal to the real-time translation server through the communication network for translation when the operation signal receiving module receives the translation operation signal, receiving a translated digital text signal corresponding to the original digital text signal and returned by the real-time translation server, replacing the original digital text signal with the translated digital text signal, and displaying the translated digital text signal and the digital television signal on the display device.

2. The real-time translation system for digital televisions according to claim 1, wherein the operating unit is a multifunctional remote controller, comprising a translation operation button.

3. The real-time translation system for digital televisions according to claim 1, wherein the real-time translation server further comprises a text comparison module and a translation database.

4. The real-time translation system for digital televisions according to claim 1, wherein the digital signal receiver, the Internet-enabled device, the operation signal receiving module, and the processor are disposed on a digital set-top box (STB), the display device is a television, and the television is connected to the processor of digital the STB.

5. The real-time translation system for digital televisions according to claim 1, wherein the digital television apparatus is an Internet-enabled digital television (DTV).

6. The real-time translation system for digital televisions according to claim 1, wherein the processor is further connected to a digital television server through the communication network to receive the digital television signal and the original digital text signal.

7. The real-time translation system for digital televisions according to claim 1, wherein the digital signal receiver is used for receives digital television signals and original digital text signals provided by a plurality of broadcasting stations through a wired or wireless network.

8. The real-time translation system for digital televisions according to claim 1, wherein the original digital text signal is a first language subtitle, and the translated digital text signal is a second language subtitle.

9. The real-time translation system for digital televisions according to claim 1, wherein after receiving the original digital text signal with a predetermined encoding length, the processor transfers the original digital text signal to the real-time translation server for translation.

10. The real-time translation system for digital televisions according to claim 1, wherein the processor further comprises a preloading procedure, for preloading the digital television video signals and the original digital text signals that are not played, and synchronously playing the digital television video signals and the translated digital text signals after receiving the translated digital text signal.

11. A real-time translation method for digital televisions, comprising:
outputting a translation operation signal by an operating unit;
receiving a digital television signal and an original digital text signal through a digital signal receiver of a digital television apparatus;
an operation signal receiving module receiving the translation operation signal;
an Internet-enabled device being connected to a real-time translation server through a communication network;
according to the translation operation signal, a processor transferring the original digital text signal to the real-time translation server through the communication network for translation;
receiving a translated digital text signal corresponding to the original digital text signal and returned by the real-time translation server; and
replacing the original digital text signal with the translated digital text signal, and displaying the translated digital text signal and the digital television signal on a display device.

12. The real-time translation method for digital televisions according to claim 11, further comprising:
the processor performing a preload procedure to preload the digital television video signals and the original digital text signals not played, and synchronously play the digital television video signals and the translated digital text signals after receiving the translated digital text signals.

13. The real-time translation method for digital televisions according to claim 12, further comprising:
the operating unit outputting a channel selection operation signal;
according to the channel selection operation signal, the digital television apparatus playing a digital television signal of a selected channel; and
when the operating unit outputs the translation operation signal, performing the preload procedure corresponding to the selected channel.

14. The real-time translation method for digital televisions according to claim 11, wherein the step of transferring the original digital text signal to the real-time translation server through the communication network for translation comprises transferring the original digital character text signal to the real-time translation server for translation after receiving the original digital text signal with a predetermined encoding length.

15. The real-time translation method for digital televisions according to claim 11, wherein the step of the real-time translation server performing translation further comprises:
obtaining an original digital text signal;
a text comparison module determining whether a part of the original digital character text signal or the whole original digital text signal exists in a translation database;
if yes, translating the original digital character signal according to data in the translation database, and listing corresponding translated unknown terms, if no, reserving the original digital text signal for translation;
analyzing unknown terms to be translated, and listing several relevant candidate translated unknown terms;
listing single word hierarchy translations of the unknown terms to be translated; and
calculating the number of occurrences of each translation combination, so as to determine a translation result of the unknown terms to be translated.

16. The real-time translation method for digital televisions according to claim 11, wherein the step of the real-time translation server performing translation further comprises:
determining that one of polysemant and phrases is comprised in a translation of the original digital text signal, and listing a candidate list for the at least one of polysemant and phrases;
selecting an appropriate combination of the unknown terms and the polysemant candidate list to generate a translation corpus and a translation result; and
comparing word meanings, and selecting a translation result of the most associated translation corpus to determine a translation result of the polysemant.
